(19) United States
(12) Patent Application Publication
(10) Pub. No.: US 2024/0313195 A1
(43) Pub. Date: Sep. 19, 2024

(54) ANODE FOR LITHIUM SECONDARY BATTERY AND LITHIUM SECONDARY BATTERY INCLUDING THE SAME

(71) Applicant: SK On Co., Ltd., Seoul (KR)

(72) Inventors: Kwang Ho JEONG, Daejeon (KR); Seung Deok SEO, Daejeon (KR)

(21) Appl. No.: 18/405,497

(22) Filed: Jan. 5, 2024

(30) Foreign Application Priority Data
Mar. 13, 2023 (KR) 10-2023-0032397

(51) Int. Cl. H01M 4/36; H01M 4/133; H01M 4/136; H01M 4/48; H01M 4/587; H01M 4/62; H01M 10/0525

(52) U.S. Cl. CPC H01M 4/364; H01M 4/133; H01M 4/136; H01M 4/483; H01M 4/587; H01M 4/622; H01M 10/0525; H01M 2004/021; H01M 2004/027

(57) ABSTRACT

Provided is an anode for a lithium secondary battery and a lithium secondary battery including the same, the anode for a secondary battery including: an anode current collector; a first anode mixture layer disposed on at least one surface of the anode current collector, and including a first silicon-based anode active material; and a second anode mixture layer disposed on the first anode mixture layer, and including a second silicon-based anode active material, wherein the second silicon-based anode active material has a higher discharge capacity than the first silicon-based anode active material.

### CROSS-REFERENCE TO RELATED APPLICATION (S)

This patent document claims the priority and benefits of Korean Patent Application No. 10-2023-0032397 filed on Mar. 13, 2023, the disclosure of which is incorporated herein by reference in its entirety.

### TECHNICAL FIELD

The present disclosure relates to an anode for a lithium secondary battery and a lithium secondary battery including the same.

### BACKGROUND

As interest in environmental issues has recently increased, exhaust gas discharged from vehicles using fossil fuels such as gasoline or diesel has been pointed out as one of the main causes of air pollution, and as a means to reduce this, a lot of research on electric vehicles (EVs), hybrid electric vehicles (HEVs), and the like is being conducted.

In addition, a lithium secondary battery having a high discharge voltage and output stability is mainly used as a power source for electric vehicles (EVs), hybrid electric vehicles (HEVs), and the like. In addition, as the necessity for a high-energy secondary battery having high energy density increases, development and research of a high-capacity anode for this purpose are also being actively conducted.

Recently, in order to implement a secondary battery having high capacity and high energy density, a silicon-based anode active material having a higher discharge capacity than graphite is applied to an anode for a secondary battery. However, a silicon-based anode material may have increased resistance due to a side reaction with an electrolyte and have a very high amount of contraction and expansion of volume during charging and discharging, thereby causing a problem of deterioration in battery lifespan characteristics due to short circuits, cracks in the active material, or the like.

Accordingly, there is a need to develop technology to suppress the resistance characteristics and contraction/expansion characteristics of silicon-based anode active material.

### SUMMARY

An aspect of the present disclosure is to provide an anode for a lithium secondary battery including a silicon-based anode active material having a high discharge capacity, and a secondary battery including the same.

According to an aspect of the present disclosure, provided is an anode for a lithium secondary battery, the anode for a lithium secondary battery including: an anode current collector; a first anode mixture layer disposed on at least one surface of the anode current collector, and including a first silicon-based anode active material; and a second anode mixture layer disposed on the first anode mixture layer, and including a second silicon-based anode active material, wherein the second silicon-based anode active material has a higher discharge capacity than the first silicon-based anode active material.

The first silicon-based anode active material may include SiOx (0≤x<2), and the second silicon-based anode active material may include SiC.

The first silicon-based anode active material may include SiOx (0≤x<2) doped with a metal element.

The metal element may be at least one selected from a group consisting of Mg, Li, Ca, Al, Fe, Ti, and V.

The first silicon-based anode active material may be included in an amount of 5 to 85% by weight based on a total weight of the first anode mixture layer.

The second silicon-based anode active material may be included in an amount of 3 to 60% by weight based on a total weight of the second anode mixture layer.

The first anode mixture layer and the second anode mixture layer may further include a carbon-based anode active material.

The second anode mixture layer may have a greater thickness than the first anode mixture layer.

A thickness ratio of the first anode mixture layer and the second anode mixture layer may be 3:7 to 4:6.

The first anode mixture layer and the second anode mixture layer may further include a binder.

The binder may include at least one selected from a group consisting of polyacrylic acid, polyacrylic amide, polyimide, polyvinyl alcohol, polyethylene glycol, polyacrylonitrile, carboxylmethyl cellulose, and copolymers of two or more thereof.

The binder may have a number average molecular weight of 50,000 to 500,000 g/mol.

The binder may include a first binder included in the first anode mixture layer and a second binder included in the second anode mixture layer, and the second binder may have a lower number average molecular weight than the first binder.

According to another aspect of the present disclosure, provided is a lithium secondary battery including the anode, a cathode, and a separator interposed between the anode and the cathode.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a view schematically illustrating a cross-section of an anode according to the present disclosure.

### DETAILED DESCRIPTION

Hereinafter, the present disclosure will be described in detail with reference to embodiments of the present disclosure shown in the attached drawings.

Since the present disclosure may be modified and have various embodiments, some embodiments will be illustrated in the drawings and described in detail in the detailed description. The effects and features of the present disclosure and methods for achieving the same will become clear by referring to the embodiments described in detail below along with the drawings. However, the present disclosure is not limited to the embodiments disclosed below and may be implemented in various forms.

Hereinafter, embodiments of the present disclosure will be described in detail with reference to the accompanying drawings. When describing with reference to the drawings, identical or corresponding components will be assigned the same reference numerals and duplicate descriptions thereof will be omitted.

In the following examples, terms such as first, second, and the like are used not in a limited sense but for the purpose of distinguishing one component from another component.

In the following examples, singular terms include plural terms unless the context clearly dictates otherwise.

In the following embodiments, terms such as include or have mean that the features or components described in the specification exist, and do not exclude in advance the possibility of adding one or more other features or components.

In the drawings, for convenience of explanation, the sizes of components may be exaggerated or reduced. For example, the size and thickness of each component shown in the drawings are shown arbitrarily for convenience of explanation, so the present disclosure is not necessarily limited to that which is shown.

In a case in which an embodiment can be implemented differently, a specific process sequence may be performed differently from the described sequence. For example, two processes described in succession may be performed at substantially the same time, or may be performed in an order opposite to the order described.

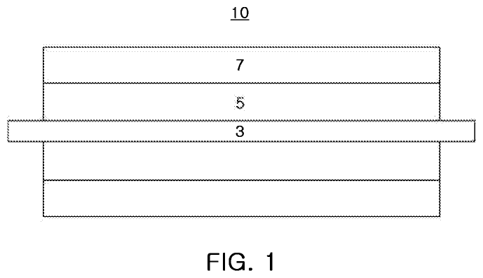

FIG. 1 is a view schematically illustrating a cross-section of an anode according to the present disclosure.

Referring to FIG. 1, an anode 10 may include a first anode mixture layer 5 disposed on at least one surface of an anode current collector 3, and a second anode mixture layer 7 disposed on the first anode mixture layer 5.

The anode current collector 3 is commonly used in manufacturing an anode of a secondary battery, and may be used without particular limitations, as long as it has conductivity without causing a chemical change in the battery. For example, as the anode current collector, copper, stainless steel, aluminum, nickel, titanium, calcined carbon, copper or stainless steel surface-treated with carbon, nickel, titanium, silver, or the like, an aluminum-cadmium alloy, or the like, may be used. In addition, by forming fine irregularities on a surface thereof, bonding strength of the anode active material may be enhanced, and various forms such as films, sheets, foils, nets, porous materials, foams, nonwoven fabrics, and the like, may be used. The anode current collector is not limited thereto, but may be, for example, 10 to 50 μm.

The first anode mixture layer 5 and the second anode mixture layer 7 may include a silicon-based anode active material. The silicon-based anode active material may be suitably used in the present disclosure as long as it can be commonly used as an anode active material, and may include, at least one selected from a group consisting of, for example, SiOx (0≤x<2), a Si—C composite, and a Si—Y alloy, where Y is an element selected from a group consisting of alkali metal, alkaline earth metal, transition metal, a group 13 element, a group 14 element, a rare earth element, and a combination thereof.

The first anode mixture layer 5 and the second anode mixture layer 7 may include different types of silicon-based anode active materials. Specifically, the first anode mixture layer 5 may include a first silicon-based anode active material, and the second anode mixture layer 7 may include a second silicon-based anode active material.

In exemplary embodiments, the second silicon-based anode active material may have a higher discharge capacity than the first silicon-based anode active material.

The first silicon-based anode active material may include, for example, Siox (0<x<2).

In an embodiment, the first silicon-based anode active material may be included in an amount of about 5 to about 85% by weight based on a total weight of the first anode mixture layer 5. In the case that the first silicon-based anode active material is included in an amount of less than about 5% by weight based on a total weight of the first anode mixture layer 5, when implementing the same capacity and energy density of the secondary battery, the second anode mixture layer 7 should contain an excess amount of the second anode active material having a high discharge capacity, and as a result, side reactions between the second silicon-based anode active material and the electrolyte may occur excessively, deteriorating the performance of the secondary battery. In addition, a content of the first silicon-based anode active material contained in the first anode mixture layer 5 may be low, so that adhesion between the first and second anode mixture layers 5 and 7 and the anode current collector 3 is reduced may not improve. In the case that the first silicon-based anode active material is included in an amount exceeding about 85% by weight based on a total weight of the first anode mixture layer 5, during charging and discharging a secondary battery, a short circuit may occur within the secondary battery due to excessive volume contraction and expansion of the first silicon-based anode active material, which may cause a problem in which the first anode mixture layer 5 is detached from the anode current collector 3. Meanwhile, the contents that the first anode mixture layer 5 includes the first silicon-based anode active material so that the adhesion between the first and second anode mixture layers 5 and 7 and the anode current collector 3 is improved will be described in detail later.

In exemplary embodiments, the first silicon-based anode active material may include Siox (0<x<2) doped with a metal element. The metal element may be at least one selected from a group consisting of Mg, Li, Ca, Al, Fe, Ti, and V.

Contraction and expansion of the first silicon-based anode active material is suppressed by the doped metal element, and thus cracks and short circuits caused by stress may be suppressed, thereby improving lifespan characteristics of the secondary battery. In addition, the first silicon-based anode active material doped with a metal element includes micropores and provides a space for the first silicon-based anode active material to expand, thereby reducing contraction and expansion of the anode 10.

The second silicon-based anode active material may include, for example, SiC.

In an embodiment, the second silicon-based anode active material may be included in an amount of about 3 to about 60% by weight based on a total weight of the second anode mixture layer 7. In the case that the second silicon-based anode active material is included in an amount less than about 3% by weight based on the total weight of the second anode mixture layer 7, the cathode 10 does not have a sufficiently high discharge capacity, it may be difficult to implement a secondary battery with high capacity and high energy density. In the case that the second silicon-based anode active material is included in an amount exceeding about 60% by weight based on the total weight of the second anode mixture layer 7, during charging and discharging of a secondary battery, a short circuit may occur within the secondary battery due to excessive volume contraction and expansion of the second silicon-based anode active material, and thus, side reactions between the second silicon-based anode active material and an electrolyte may occur excessively, thereby increasing resistance of the anode 10 and ultimately deteriorating the performance of the secondary battery.

In exemplary embodiments, the second anode mixture layer 7 may have a greater thickness than the first anode mixture layer 5. Accordingly, since a content ratio of the second silicon-based anode active material with high discharge capacity and a low contraction/expansion rate increases in an entire anode mixture layer, the capacity and energy density of the anode 10 may further increase, and the contraction and expansion may be further suppressed. In an embodiment, a thickness ratio of the first anode mixture layer 5 and the second anode mixture layer 7 may be about 3:7 to about 4:6.

The first anode mixture layer 5 and the second anode mixture layer 7 may further include a carbon-based anode active material. The carbon-based anode active material may be suitably used in the present disclosure as long as it can be commonly used as an anode active material, and may include, for example, artificial graphite or natural graphite.

The first anode mixture layer 5 and the second anode mixture layer 7 may further include a binder.

The binder may include at least one selected from a group consisting of a rubber-based binder and a water-soluble polymer-based binder.

The rubber-based binder may not be dissolved in an aqueous solvent such as water, or the like, but have water dispersibility capable of being smoothly dispersed in an aqueous solvent, and may include, for example, at least one selected from a group consisting of styrene butadiene rubber (SBR), hydrogenated nitrile butadiene rubber (HNBR), acrylonitrile butadiene rubber, acrylic rubber, butyl rubber, and fluoro rubber.

The water-soluble polymer-based binder may be dissolved in an aqueous solvent such as water, or the like, and may include, for example, at least one selected from a group consisting of polyacrylic acid, polyacrylic amide, polyimide, polyvinyl alcohol, polyethylene glycol, polyacrylonitrile, carboxymethyl cellulose, and copolymers of two or more thereof.

Specifically, in exemplary embodiments, the binder may include, for example, at least one selected from a group consisting of polyacrylic acid (PAA), polyacrylic amide, polyimide, polyvinyl alcohol (PVA), and copolymers of two or more thereof.

Hereinafter, for convenience of explanation, at least one selected from a group consisting of polyacrylic acid, polyacrylic amide, polyimide, polyvinyl alcohol, and copolymers of two or more thereof will be referred to as a PAA-based binder.

The PAA-based binder may form a hydrogen bond with an oxygen functional group of SiOx (0<x<2) included in the first silicon-based anode active material, so that adhesion is formed between the first and second anode mixture layers 5 and 7 and the anode current collector 3. In an embodiment, the first silicon-based anode active material may include, for example, silanol or siloxane.

In addition, the PAA-based binder may have appropriate brittleness characteristics to further suppress contraction and expansion of the first silicon-based anode active material and the second silicon-based anode active material, and have low resistance characteristics to suppress an increase in the resistance of the anode 10.

In an embodiment, the PAA-based binder may have a number average molecular weight (Mn) of about 50,000 to about 500,000 g/mol. In the case that the PAA-based binder has a number average molecular weight of less than about 50,000 g/mol, the adhesion between the first and second anode mixture layers 5 and 7 and the anode current collector 3 may be reduced, resulting in detachment of the first and second anode mixture layers 5 and 7 and the anode current collector 3 may occur. In the case that the PAA-based binder has a number average molecular weight of about 500,000 g/mol or more, the brittleness characteristics of the PAA-based binder may increase excessively, so that the anode active material may be detached from the first and second anode mixture layers or the first and second anode mixture layers, and detachment of the cathode mixture layers 5 and 7 may occur.

Meanwhile, the number average molecular weight of the PAA-based binder may be measured by gel permeation chromatography (GPC) using a polystyrene standard. The number average molecular weight of the PAA-based binder may be measured under commonly applied temperature, solvent, and flow rate conditions, using a commonly known analysis device, a detector such as a refractive index detector, or the like, and a column for analysis. In detail, the number average molecular weight of the PAA-based binder may be measured using a Polymer Laboratories PLgel MIX-B 300 mm long column and a Waters PL-GPC220 device, wherein an evaluation temperature is 160° C., a solvent is 1,2,4-trichlorobenzene, a flow rate is 1 mL/min, and a sample prepared at a concentration of 10 mg/10 mL and supplied in an amount of 200 μL, and using a black calibration curve formed using a polystyrene standard.

In exemplary embodiments, the binder may include a first binder included in the first anode mixture layer 5 and a second binder included in the second anode mixture layer 7, and the first binder and the second binder may be the PAA-based binder.

In an embodiment, the second binder may have a lower number average molecular weight than the first binder.

Meanwhile, as the number average molecular weight of the PAA-based binder decreases, a phenomenon in which the PAA-based binders are entangled with each other decreases, so the PAA-based binder having a low number average molecular weight can have lower resistance characteristics. Accordingly, the second anode mixture layer 7 located on a surface of an entire anode mixture layer includes the PAA-based binder having a low number average molecular weight, thereby further suppressing an increase in resistance of the anode 10.

In an embodiment, the first binder may have a number average molecular weight of about 100,000 to about 500,000 g/mol, and the second binder may have a number average molecular weight of about 50,000 to about 100,000 g/mol.

In an embodiment, the binder may be included in an amount of about 1.5 to about 5% by weight based on a total weight of the first anode mixture layer 5 and the second anode mixture layer 7.

In addition, the first anode mixture layer 5 and the second anode mixture layer 7 may further include a conductive agent. The conductive agent is not particularly limited, but may include, for example, at least one selected from a group of graphite, carbon black, carbon nanotubes such as MWCNT, SWCNT, and TWCNT, metal powder, and conductive oxide.

In an embodiment, the conductive agent may be included in an amount of about 0.05 to about 0.2% by weight based on a total weight of the first anode mixture layer 5 and the second anode mixture layer 7.

As described above, the first anode mixture layer 5 may include the first silicon-based anode active material, and the second anode mixture layer 7 may include the second silicon-based anode active material having a higher discharge capacity than the first silicon-based anode active material. Accordingly, even if the second anode mixture layer 7 contains a low content of the second silicon-based anode active material, a secondary battery with high capacity and high energy density may be implemented. That is, since the second anode mixture layer 7 includes a low content of the second silicon-based anode active material, contraction and expansion of the second anode mixture layer 7 may be suppressed, and as a side reaction between the second silicon-based anode active material and an electrolyte is suppressed, an increase in resistance of the anode 10 may be suppressed, thereby ultimately improving the performance of the secondary battery.

In addition, when charging a secondary battery, charging may be performed from the second anode mixture layer 7 located on a surface of the entire anode mixture layer, and the second anode mixture layer 7 includes the second silicon-based anode active material having a high discharge capacity, so that more lithium ions can be more easily inserted into and detached from the second silicon-based anode active material. Accordingly, the general charging characteristics and rapid charging characteristics of the secondary battery can be improved.

In addition, the first anode mixture layer 5 and the second anode mixture layer 7 may include the PAA-based binder. The PAA-based binder may have appropriate brittleness characteristics to further suppress contraction and expansion of the first silicon-based anode active material and the second silicon-based anode active material, and the PAA-based binder may low resistance characteristics to suppress an increase in resistance of the anode 10.

Furthermore, the second anode mixture layer 7 located on the surface of the entire anode mixture layer may include the PAA-based binder having a low number average molecular weight, so that the increase in the resistance of the anode 10 can be further suppressed.

In addition, the PAA-based binder may form a hydrogen bond with an oxygen functional group of SiOx (0<x<2) included in the first silicon-based anode active material, so that the adhesion between the first and second anode mixture layers 5 and 7 and the anode current collector 3 may be improved.

For example, an anode mixture composition including the anode active material and a binder in a solvent may be mixed to prepare an anode slurry, and the anode slurry may be coated/deposited on an anode current collector and then dried and rolled to prepare an anode mixture layer. The anode mixture layer may further include a binder and optionally may further include a conductive agent, a thickener, and the like.

The coating process may be performed using methods such as gravure coating, slot die coating, imprinting, doctor blade coating, dip coating, bar coating, casting, and the like, but the present disclosure is not limited thereto.

The coating may be performed so that an anode slurry (first anode slurry) forming a first anode mixture layer and an anode slurry (second anode slurry) forming a second anode mixture layer may be coated simultaneously, or the first anode slurry may be applied and then the second anode slurry may be coated separately, or the first anode slurry may be applied and dried and then the second anode slurry may be applied and dried.

In some embodiments, the anode may include an anode active material layer in a form of lithium metal formed through a deposition/coating process.

In manufacturing the anode slurry, the solvent is not limited thereto, but the solvent may include, for example, water, pure water, deionized water, distilled water, ethanol, isopropanol, methanol, acetone, n-propanol, t-butanol, and the like.

Another aspect of the present disclosure is to provide a secondary battery including an anode according to each of the above-described embodiments. The secondary battery includes the anode, a cathode, and a separator interposed between the anode and the cathode.

The cathode may include a cathode current collector and a cathode mixture layer disposed on at least one surface of the cathode current collector.

The cathode current collector may include stainless steel, nickel, aluminum, titanium, or alloys thereof. The cathode current collector may include aluminum surface-treated with carbon, nickel, titanium, or silver or stainless steel surface-treated with carbon, nickel, titanium, or silver. The cathode current collector is not limited thereto, but may be, for example, 10 to 50 μm.

The cathode mixture layer may include a cathode active material. The cathode electrode active material may include a compound capable of reversibly intercalating and deintercalating lithium ions.

According to exemplary embodiments, the cathode active material may include lithium-nickel metal oxide. The lithium-nickel metal oxide may further include at least one of cobalt (Co), manganese (Mn), and aluminum (Al).

In some embodiments, the cathode active material or the lithium-nickel metal oxide may include a layered structure or a crystal structure represented by Formula 1 below.

LiₓNiₐM_{b}O_{2+z} [Formula 1]

In Formula 1, 0.9≤x≤1.2, 0.6≤a≤0.99, 0.01≤b≤0.4, and −0.5≤z≤0.1 may be satisfied. As described above, M may include Co, Mn, and/or Al.

A chemical structure represented by Formula represents a bonding relationship included in the layered structure or crystal structure of the cathode active material and does not exclude other additional elements. For example, M includes Co and/or Mn, and Co and/or Mn may be provided as a main active element of the cathode active material along with Ni. Formula 1 is provided to express the bonding relationship of the main active elements and should be understood as encompassing the introduction and substitution of additional elements.

In an embodiment, in addition to the main active element, auxiliary elements to improve chemical stability of the cathode active material or the layered structure/crystal structure may be further included.

The auxiliary elements may be incorporated into the layered structure/crystal structure to form a bond, and in this case, it should be understood that they are included within a range of the chemical structure represented by Formula 1. The auxiliary element may include at least one, for example, of Na, Mg, Ca, Y, Ti, Hf, V, Nb, Ta, Cr, Mo, W, Fe, Cu, Ag, Zn, B, Al, Ga, C, Si, Sn, Sr, Ba, Ra, P, or Zr. For example, the auxiliary element, such as Al, may act as an auxiliary active element contributing to capacity/output activity of the cathode active material together with Co or Mn.

For example, the cathode active material or the lithium-nickel metal oxide may include a layered structure or crystal structure represented by the following Formula 1-1.

LiₓNiₐM1_{b1}M2_{b2}O_{2+z} [Formula 1-1]

In Formula 1-1, M1 may include Co, Mn, and/or Al. M2 may include the auxiliary elements described above. In Formula 1-1, 0.9≤x≤1.2, 0.6≤a≤0.99, 0.01≤b1+b2≤0.4, −0.5≤z≤0.1 may be satisfied.

The cathode active material may further include a coating element or a doping element. For example, elements, substantially the same or similar to the above-described auxiliary elements may be used as coating elements or doping elements.

The coating element or doping element may exist on a surface of a lithium-nickel metal oxide particle, or may penetrate through the surface of the lithium-nickel metal composite oxide particle and be included in the bonding structure represented by Formula 1 or Formula 1-1.

The cathode active material may include an nickel-cobalt-manganese (NCM)-based lithium oxide. In this case, an NCM-based lithium oxide with increased nickel content can be used.

Ni may be provided as a transition metal related to an output and capacity of lithium secondary batteries. Therefore, by adopting a high-Ni composition as the cathode active material as described above, a cathode with high capacity and a lithium secondary battery with high capacity may be provided.

However, as an Ni content increases, long-term storage stability and lifespan stability of the cathode or secondary battery may relatively decrease, and a side reaction with an electrolyte may also increase. However, according to exemplary embodiments, electrical conductivity may be maintained by including Co, while lifespan stability and capacity retention characteristics may be improved through Mn.

The content of Ni (for example, a mole fraction of nickel in the total number of moles of nickel, cobalt, and manganese) in the NCM-based lithium oxide may be 0.6 or more, 0.7 or more, or 0.8 or more. In some embodiments, the Ni content may be 0.8 to 0.95, 0.82 to 0.95, 0.83 to 0.95, 0.84 to 0.95, 0.85 to 0.95, or 0.88 to 0.95.

In some embodiments, the cathode active material may include a lithium cobalt oxide-based active material, a lithium manganese oxide-based active material, a lithium nickel oxide-based active material, or a lithium iron phosphate (LFP)-based active material (e.g., LiFePO₄).

In some embodiments, the cathode active material may include, for example, an Mn-rich-based active material having a chemical structure or crystal structure represented by Formula 2, a Li rich layered oxide (LLO)/Over Lithiated Oxide (OLO)-based active material, and a Co-less-based active material.

p[Li₂MnO₃]·(1−p)[Li_{q}JO₂] [Formula 2]

In Formula 2, 0<p<1 and 0.9≤q≤1.2 are satisfied, where J may include at least one element among Mn, Ni, Co, Fe, Cr, V, Cu, Zn, Ti, Al, Mg, and B.

For example, a cathode slurry may be prepared by mixing the cathode active material in a solvent. The cathode slurry may be coated on a cathode current collector, and then dried and rolled to prepare a cathode mixture layer. The coating process may be performed by methods such as gravure coating, slot die coating, multi-layer simultaneous die coating, imprinting, doctor blade coating, dip coating, bar coating, casting, and the like, but the present disclosure is not limited thereto. The cathode mixture layer may further include a binder and optionally may further include a conductive agent, a thickener, and the like.

The solvent used to prepare the cathode slurry is not limited thereto, but may include, for example, N-methyl-2-pyrrolidone (NMP), dimethylformamide, dimethylacetamide, N, N-dimethylaminopropylamine, ethylene oxide, tetrahydrofuran, and the like.

The binder may include polyvinylidenefluoride (PVDF), poly(vinylidene fluoride-co-hexafluoropropylene, polyacrylonitrile, polymethylmethacrylate, acrylonitrile butadiene rubber (NBR), polybutadiene rubber (BR), styrene-butadiene rubber (SBR), and the like. In an embodiment, a PVDF-based binder may be used as a cathode binder.

The conductive material may be added to improve conductivity of the cathode mixture layer and/or mobility of lithium ions or electrons. For example, the conductive material may include a carbon-based conductive material such as graphite, carbon black, acetylene black, Ketjen black, graphene, carbon nanotubes, vapor-grown carbon fiber (VGCF), carbon fiber, and/or a metal-based conductive material including a perovskite material such as tin, tin oxide, titanium oxide, LaSrCoO₃, and LaSrMnO₃, but the present disclosure is not limited thereto.

If necessary, the cathode mixture layer may further include a thickener and/or a dispersant. In an embodiment, the cathode mixture may include a thickener such as carboxymethylcellulose (CMC).

The separator interposed between the cathode and the anode may be configured to prevent an electrical short circuit between the cathode and the anode and to generate a flow of ions. As an example, a thickness of the separator is not limited thereto, but may be, for example, 10 μm to 20 μm.

For example, the separator may include a porous polymer film or a porous non-woven fabric. The porous polymer film may include a polyolefin-based polymer such as an ethylene polymer, a propylene polymer, ethylene/butene copolymer, an ethylene/hexene copolymer, an ethylene/methacrylate copolymer, and the like. The porous nonwoven fabric may include high melting point glass fiber, polyethylene terephthalate fiber, and the like. The separator may include a ceramic-based material. For example, inorganic particles may be coated on the polymer film, or dispersed within the polymer film to improve heat resistance.

The separator may have a single-layer or multi-layer structure including the polymer film and/or non-woven fabric described above.

In the secondary battery according to the present disclosure, as an embodiment, an electrode assembly may be formed by repeatedly disposing a cathode, an anode, and a separator. Furthermore, in some embodiments, the electrode assembly may be a winding type, a stack type, a zigzag folding (z-folding) type, or a stack-folding type.

An electrolyte solution may be accommodated in a battery case along with the electrode assembly to define a lithium secondary battery. According to an embodiment, the electrolyte solution may be a non-aqueous electrolyte solution.

The non-aqueous electrolyte solution may include a lithium salt as an electrolyte and an organic solvent. The lithium salt may be expressed, and as an anion (X⁻) of the lithium salt, F⁻, Cl⁻, Br⁻, I⁻, NO₃⁻, N(CN)₂⁻, BF₄⁻, ClO₄⁻, PF₆⁻, (CF₃)₂PF₄, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂ (CF₃)₂CO⁻, (CF₃SO₂)₂CH⁻, (SF₅)₃C⁻, (CF₃SO₂)₃C⁻, CF₃ (CF₂)₇SO₃⁻, CF₃CO₂⁻, CH₃CO₂⁻, SCN⁻, (CF₃CF₂SO₂)₂N⁻, and the like, may be exemplified.

The organic solvent may include an organic compound that has sufficient solubility in the lithium salt and additives added to the electrolyte solution as necessary, and is not reactive in the battery. The organic solvent may include, for example, at least one of a carbonate-based solvent, an ester-based solvent, an ether-based solvent, a ketone-based solvent, an alcohol-based solvent, and an aprotic solvent. Examples of the organic solvent may include propylene carbonate (PC), ethylene carbonate (EC), butylene carbonate, diethyl carbonate (DEC), dimethyl carbonate (DMC), ethylmethyl Carbonate (EMC), methylpropyl Carbonate, ethylpropyl Carbonate, dipropyl Carbonate, vinylene carbonate, methyl acetate (MA), ethyl acetate (EA), n-propylacetate (n-PA), 1,1-dimethylethyl acetate (DMEA), methyl propionate (MP), ethyl propionate (EP), fluoroethyl acetate (FEA), difluoroethyl acetate (DFEA), trifluoroethyl acetate (TFEA), dibutyl ether, tetraethylene glycol dimethyl ether (TEGDME), diethylene glycol dimethyl ether (DEGDME), dimethoxyethane, tetrahydrofuran (THF), 2-methyltetrahydrofuran, ethyl alcohol, isopropyl alcohol, dimethylsulfuroxide, acetonitrile, dimethoxyethane, diethoxyethane, sulfolane, gamma-butyrolactone, propylene sulfite, and the like. These may be used alone or in combination of two or more thereof as the organic solvent.

The non-aqueous electrolyte solution may further include an additive. The additive may include, for example, a cyclic carbonate-based compound, a fluorine-substituted carbonate-based compound, a sultone-based compound, a cyclic sulfate-based compound, a cyclic sulfite-based compound, a phosphate-based compound, and a borate-based compound.

The cyclic carbonate-based compound may include vinylene carbonate (VC), vinyl ethylene carbonate (VEC), and the like.

The fluorine-substituted carbonate-based compound may include fluoroethylene carbonate (FEC), or the like.

The sultone-based compounds include 1,3-propane sultone, 1,3-propene sultone, 1,4-butane sultone, and the like.

The cyclic sulfate-based compound may include 1,2-ethylene sulfate, 1,2-propylene sulfate, and the like.

The cyclic sulfite-based compound may include ethylene sulfite, buthylene sulfite, and the like.

The phosphate-based compound may include lithium difluoro bis-oxalato phosphate, lithium difluoro phosphate, and the like.

The borate-based compound may include lithium bis(oxalate) borate, or the like.

In the secondary battery, for example, electrode tabs (cathode tab and anode tab) may protrude from the cathode current collector and the anode current collector, respectively, and may extend to one side portion of the battery case. For example, the battery case may be a pouch-type case, a square-type case, a cylindrical-type case, a coin-type case, and the like.

For example, the electrode tabs may extend or be exposed outwardly from the one side portion of the battery case and be connected to electrode leads (cathode lead and anode lead). When the battery case is a pouch-type case, the electrode tab extending outwardly from one side portion of the battery case may be fused together with the battery case.

### Example

Hereinafter, the present disclosure will be described in more detail with reference to examples. The following examples are intended to represent an example of the present disclosure, and are not intended to limit the present disclosure thereby.

### Examples 1 to 5 and Comparative Examples 1 to 3

A first anode slurry of Examples 1 to 5 and Comparative Examples 1 to 3 was prepared, respectively, by mixing SiOx (0<x<2) or Sic as a silicon-based anode active material, graphite as a carbon-based anode active material, a PAA-PVA copolymer or SBR/CMC as a binder, and CNT as a conductive agent with water as a solvent in the contents illustrated in Table 1.

In addition, a second anode slurry of Examples 1 to 5 and Comparative Examples 1 to 3 was prepared, respectively, by mixing Siox (0<x<2) or Sic as a silicon-based anode active material, graphite as a carbon-based anode active material, a PAA-PVA copolymer or SBR/CMC as a binder, and CNT as a conductive agent with water as a solvent in the contents illustrated in Table 1.

TABLE 1

| | | | | | | Binder | | | |
|---|---|---|---|---|---|---|---|---|---|
| | | | | | | Type | | | |
| | | | | | | (number | | | |
| | | | | | | average | | | |
| | | Silicon-based | | Carbon-based | | molecular | | Conductive | |
| | | active material | | active material | | weight | | agent | |
| | | Type | Weight % | Type | Weight % | (g/mol)) | Weight % | Type | Weight % |
| Example | First | SiOx | 25 | Graphite | 71.3 | CMC/SBR | 3.6 | CNT | 0.1 |
| 1 | mixture | | | | | | | | |
| | layer | | | | | | | | |
| | Second | SiC | 15 | | 83.1 | | 1.8 | | 0.1 |
| | mixture | | | | | | | | |
| | layer | | | | | | | | |
| Example | First | SiOx | 25 | Graphite | 71.3 | PAA-PVA | 3.6 | CNT | 0.1 |
| 2 | mixture | | | | | copolymer | | | |
| | layer | | | | | (50,000) | | | |
| | Second | SiC | 15 | | 83.1 | | 1.8 | | 0.1 |
| | mixture | | | | | | | | |
| | layer | | | | | | | | |
| Example | First | SiOx | 25 | Graphite | 71.3 | PAA-PVA | 3.6 | CNT | 0.1 |
| 3 | mixture | | | | | copolymer | | | |
| | layer | | | | | (50,000) | | | |
| | Second | SiC | 15 | | 73.1 | PAA-PVA | 1.8 | | 0.1 |
| | mixture | | | | | copolymer | | | |
| | layer | | | | | (300,000) | | | |
| Example | First | SiOx | 25 | Graphite | 81.3 | PAA-PVA | 3.6 | CNT | 0.1 |
| 4 | mixture | | | | | copolymer | | | |
| | layer | | | | | (300,000) | | | |
| | Second | SiC | 15 | | 83.1 | | 1.8 | | 0.1 |
| | mixture | | | | | | | | |
| | layer | | | | | | | | |
| Example | First | SiOx | 25 | Graphite | 71.3 | PAA-PVA | 3.6 | CNT | 0.1 |
| 5 | mixture | | | | | copolymer | | | |
| | layer | | | | | (300,000) | | | |
| | Second | SiC | 15 | | 83.1 | PAA-PVA | 1.8 | | 0.1 |
| | mixture | | | | | copolymer | | | |
| | layer | | | | | (50,000) | | | |
| Comparative | First | SiOx | 25 | Graphite | 71.3 | CMC/SBR | 3.6 | CNT | 0.1 |
| Example | mixture | | | | | | | | |
| 1 | layer | | | | | | | | |
| | Second | SiOx | 25 | | 73.1 | | 1.8 | | 0.1 |
| | mixture | | | | | | | | |
| | layer | | | | | | | | |
| Comparative | First | SiC | 15 | Graphite | 81.3 | CMC/SBR | 3.6 | CNT | 0.1 |
| Example | mixture | | | | | | | | |
| 2 | layer | | | | | | | | |
| | Second | SiC | 15 | | 83.1 | | 1.8 | | 0.1 |
| | mixture | | | | | | | | |
| | layer | | | | | | | | |
| Comparative | First | SiC | 15 | Graphite | 71.3 | CMC/SBR | 3.6 | CNT | 0.1 |
| Example | mixture | | | | | | | | |
| 3 | layer | | | | | | | | |
| | Second | SiOx | 25 | | 73.1 | | 1.8 | | 0.1 |
| | mixture | | | | | | | | |
| | layer | | | | | | | | |

Thereafter, after applying the first anode slurry on a copper foil as an anode current collector, and dried at 80° C. to form a first anode mixture layer, and after applying a second anode slurry on the first anode mixture layer, and dried at 80° C. to form a second anode mixture layer to prepare an anode of Examples 1 to 5 and Comparative Examples 1 to 3.

Thereafter, a cathode slurry including an NCM-based active material, which is a lithium-transition metal complex oxide, was applied and dried on an aluminum foil (Al foil) as a cathode current collector to prepare a cathode.

An electrode assembly was prepared by interposing a polyolefin separator between the cathode and the anode, the electrode assembly was inserted into a pouch for a secondary battery, an electrolyte dissolved with LiPF₆ of 1M was injected in a solvent mixed with carbonate (EC) and diethyl carbonate (DEC), then sealed to prepare a pouch-type lithium secondary battery of Examples 1 to 5 and Comparative Examples 1 to 3 with a capacity of 80 Ah, respectively.

### Adhesion Measurement

For the anode of Examples 1 to 5 and Comparative Examples 1 to 3, a 90-degree peel test for measuring a force required to attach and remove a tape having a width of 18 mm using IMADA's DS2-50N was performed, so that adhesion between the first and second anode mixture layers and the anode current collector was measured, and the results thereof were shown in Table 2.

### Expansion Rate Measurement

An initial thickness (t1) of the anode electrode of Examples 1 to 5 and Comparative Examples 1 to 3 was measured. Thereafter, a lithium secondary battery was charged to 100% in a state of charge (SoC), and then the lithium secondary battery was dismantled, and a thickness (t2) of the anode after charging the anode was measured. An expansion rate of the anode was calculated according to Equation 1 below, and the results thereof were shown in Table 2.

Expansion rate (%)=(t2−t1)/t1 [Equation 1]

### Resistance Measurement

For a lithium secondary battery of Examples 1 to 5 and Comparative Examples 1 to 3, after applying a discharge current corresponding 1 C for 10 seconds in a state of charge (SoC) of 50%, resistance of the anode (direct current internal resistance (DC-IR) was measured, and the results thereof are illustrated in Table 2 below.

### Normal Lifespan Capacity Retention Measurement

The lithium secondary battery was discharged at 2.5V at 0.3 C at a temperature of 25° C., charged with a constant current to 4.2V, and then charged with a constant voltage (CV) at 0.05 C repeatedly, to measure a discharge capacity of the lithium secondary battery. Based on the measured discharge capacity of the lithium secondary battery, 0.33 C CC/CV of charging and 0.5 C of discharging were repeated 300 times in a range of 4 to 98% in a state of charge (SoC), and a normal lifespan capacity retention rate was measured, and the results thereof were shown in Table 2 below.

### Rapid Charging Lifespan Capacity Retention Rate Measurement

After inserting a LTO (Li₄Ti₅O₁₂) reference electrode into a jelly roll on which a cathode/separator/Example 1 to 5 and an anode of Comparative Examples 1 to 3 were stacked, a three-electrode battery of Examples 1 to 5 and Comparative Examples 1 to 3 were manufactured, respectively, using the same manufacturing method as the pouch-type lithium secondary battery. In this case, the LTO reference electrode was manufactured by removing a distal end of an insulating-coated copper foil and then coating an LTO slurry including 97% by weight of LTO, 2% by weight of Super P, and 1% by weight of PVDF based on the total weight.

Thereafter, the three-electrode battery was CC charged up to 4.2V at a current rate (C-rate) of 1.25 to 3.0 C, a SOC point at which a closed circuit voltage (CCV) value of an anode for each C-rate becomes constant below 0V was found, and the SOC point was designated as a charge limit, and a step-charging protocol of the three-electrode battery of Examples 1 to 5 and Comparative Examples 1 to 3 was produced.

Thereafter, after calculating a charging time of the three-electrode battery using the step charging protocol, the step-charging protocol of the three-electrode battery of Examples 1 to 5 and Comparative Examples 1 to 3 was applied to the pouch-type lithium secondary battery of Examples 1 to 5 and Comparative Examples 1 to 3, and rapid charging and ⅓C discharging were repeated for each pouch-type lithium secondary battery for 300 cycles to measure a rapid charging lifespan capacity retention rate, and the results thereof were shown in Table 2 below.

TABLE 2

| | | | | | Rapid |
|---|---|---|---|---|---|
| | | | | Normal | charging |
| | | | | lifespan | lifespan |
| | | | | capacity | capacity |
| | Adhesion | Expansion | Resistance | retention | retention |
| | (N/18 mm) | rate (%) | (mΩ) | rate (%) | rate (%) |
| Example 1 | 0.29 | 50.9 | 1.039 | 88.6 | 80.7 |
| Example 2 | 0.35 | 46.1 | 0.991 | 92.6 | 87.4 |
| Example 3 | 0.34 | 46.4 | 1.031 | 90.2 | 83.2 |
| Example 4 | 0.77 | 46.2 | 1.035 | 93.1 | 85.1 |
| Example 5 | 0.75 | 46.3 | 0.994 | 94.3 | 88.6 |
| Comparative | 0.28 | 55.6 | 1.037 | 81.2 | 70.4 |
| Example 1 | | | | | |
| Comparative | 0.2 | 48.3 | 1.041 | 86.3 | 74.6 |
| Example 2 | | | | | |
| Comparative | 0.19 | 51.7 | 1.037 | 83.8 | 72.2 |
| Example 3 | | | | | |

As can be seen from Table 2, it was confirmed that the lithium secondary battery of Examples 1 to 5 had a higher general lifespan capacity retention rate and more rapid charging lifespan capacity retention rate than the lithium secondary battery of Comparative Examples 1 to 3. Therefrom, as proposed in the present disclosure, the second anode mixture layer 7 located on a surface of the entire anode mixture layer includes the second silicon-based anode active material having a high discharge capacity, so that it can be seen that the general charging characteristics and rapid charging characteristics of the secondary battery are improved.

In addition, it was confirmed that the anode of Examples 2 to 5 had a lower expansion rate and lower resistance than the anode of Comparative Examples 1 and 3, and the anode of Example 1 had a lower expansion rate than the anode of Comparative Example 3. Therefrom, as proposed in the present disclosure, the second anode mixture layer 7 includes a low content of the second silicon-based anode active material having a higher discharge capacity than the first silicon-based anode active material, so that it can be seen that an increase in resistance of the anode 10 is suppressed as the contraction and expansion of the second anode mixture layer 7 is suppressed and a side reaction between the second silicon-based anode active material and an electrolyte solution is suppressed.

In addition, it can be seen that the anodes of Examples 2 to 5 have a lower expansion rate and lower resistance than the anode of Example 1. Therefrom, as proposed in the present disclosure, it can be seen that the PAA-based binder has appropriate brittleness characteristics, to further suppress contraction and expansion of the first silicon-based anode active material and the second silicon-based anode active material, and the PAA-based binder has low resistance characteristics to suppress an increase in resistance of the anode 10.

In addition, it can be seen that the anodes of Examples 2 and 5 have lower resistance than the anodes of Examples 3 and 4. Therefrom, as proposed in the present disclosure, the second anode mixture layer 7 located on a surface of the entire anode mixture layer includes a low content of the second silicon-based anode active material having a higher discharge capacity than the first silicon-based anode active material, so that it can be seen that the increase in the resistance of the anode 10 may be further suppressed.

In addition, it was confirmed that the anodes of Examples 2 to 5 had higher adhesion than the anodes of Comparative Examples 1 to 3. Therefrom, as proposed in the present disclosure, the PAA-based binder forms a hydrogen bond with an oxygen functional group of SiOx (0<x<2) included in the first silicon-based anode active material, so that it can be seen that the adhesion between the first and second anode mixture layers 5 and 7 and the anode current collector 3 may be improved.

As set forth above, according to embodiments of the present disclosure, a secondary battery having high capacity and high energy density may be implemented.

In addition, according to another aspect of the present disclosure, contraction and expansion of an anode electrode mixture layer on a surface of the anode may be suppressed, and a side reaction between an anode active material and an electrolyte solution may be suppressed, and thus, an increase in resistance of the anode may be suppressed, ultimately improving the performance of the secondary battery.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed to have a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An anode for a lithium secondary battery, comprising:
an anode current collector;
a first anode mixture layer disposed on at least one surface of the anode current collector, and including a first silicon-based anode active material; and
a second anode mixture layer disposed on the first anode mixture layer, and including a second silicon-based anode active material,
wherein the second silicon-based anode active material has a higher discharge capacity than the first silicon-based anode active material.

2. The anode for a lithium secondary battery of claim 1, wherein the first silicon-based anode active material comprises Siox (0<x<2), and the second silicon-based anode active material comprises SiC.

3. The anode for a lithium secondary battery of claim 2, wherein the first silicon-based anode active material comprises SiOx (0<x<2) doped with a metal element.

4. The anode for a lithium secondary battery of claim 3, wherein the metal element is at least one selected from a group consisting of Mg, Li, Ca, Al, Fe, Ti, and V.

5. The anode for a lithium secondary battery of claim 1, wherein the first silicon-based anode active material is included in an amount of 5 to 85% by weight with respect to a total weight of the first anode mixture layer.

6. The anode for a lithium secondary battery of claim 1, wherein the second silicon-based anode active material is included in an amount of 3 to 60% by weight with respect to a total weight of the second anode mixture layer.

7. The anode for a lithium secondary battery of claim 1, wherein the first anode mixture layer and the second anode mixture layer further comprise a carbon-based anode active material.

8. The anode for a lithium secondary battery of claim 1, wherein the second anode mixture layer has a greater thickness than the first anode mixture layer.

9. The anode for a lithium secondary battery of claim 1, wherein the first anode mixture layer and the second anode mixture layer have a thickness ratio of 3:7 to 4:6.

10. The anode for a lithium secondary battery of claim 1, wherein the first anode mixture layer and the second anode mixture layer further comprise a binder.

11. The anode for a lithium secondary battery of claim 10, wherein the binder comprises at least one selected from a group consisting of polyacrylic acid, polyacrylic amide, polyimide, polyvinyl alcohol, polyethylene glycol, polyacrylonitrile, carboxylmethyl cellulose, and copolymers of two or more thereof.

12. The anode for a lithium secondary battery of claim 10, wherein the binder has a number average molecular weight of 50,000 to 500,000 g/mol.

13. The anode for a lithium secondary battery of claim 10, wherein the binder comprises
a first binder included in the first anode mixture layer; and
a second binder included in the second anode mixture layer,
wherein the second binder has a lower number average molecular weight than the first binder.

14. A lithium secondary battery, comprising:
the anode of claim 1, a cathode, and a separator interposed between the anode and the cathode.
